(19) United States
(12) Patent Application Publication
(10) Pub. No.: US 2005/0057528 A1
(43) Pub. Date: Mar. 17, 2005

(54) Screen having a touch-sensitive user interface for command input

(76) Inventor: Martin Kleen, Neunkirchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/927,812

(22) Filed: Aug. 27, 2004

(30) Foreign Application Priority Data
Sep. 1, 2003 (DE) 10340188.1

(51) Int. Cl. G09G 5/00

(52) U.S. Cl. 345/173

(57) ABSTRACT

Screen having a touch-sensitive user interface (8) for command input via local touching of the user interface (8) and generation of a command signal where the extent of touch is sufficient, comprising electrically actuatable means (5) assigned to the user interface (8) to generate a signal that is haptically perceptible to the user in the position touched on the user interface (8), depending on a command signal being generated.

### CROSS REFERENCE TO RELATED APPLICATIONS

This application claims priority to the German application No. 10340188.1, filed Sep. 1, 2003 and which is incorporated by reference herein in its entirety.

### FIELD OF INVENTION

The invention relates to a screen having a touch-sensitive user interface for command input through localized touching of the user interface and generation of a command signal when the touch is sufficient.

### BACKGROUND OF INVENTION

Such screens, which are also often referred to as “touch screens,” are sufficiently well known and are used wherever the user communicates interactively with the data processing device assigned to the screen, irrespective of type. In order to make an input that leads to a reaction on the part of the assigned data processing device, irrespective of type, or to the provision of information, and which is generally referred to below as a “command input”, the user simply touches the user interface in the corresponding, optionally optically enhanced position. The touch is detected by a detection means assigned to the user interface and when the touch is sufficient, a corresponding command signal resulting from the command input is produced and supplied to the data processing device. If the touch has been sufficient to input a command, that is, if a command signal has been generated, then an optical acknowledgement is usually made via the screen. For instance, the display on the screen changes or the region that has been touched, which has shown an input key or suchlike for example, is shown in a different color, etc.

### SUMMARY OF INVENTION

The before mentioned known touch screens include some disadvantages. Firstly, the optical acknowledgement is often not clear, and it is hard to see, which is the case in particular with screens with liquid crystal displays against a somewhat lighter background or an oblique angle of vision. This causes problems in particular for users who have fairly poor or poor sight. Moreover, the user has to direct his attention to the screen at the very moment that the acknowledgement is given to him. However, this is frequently not possible in cases where the control of a device or a unit is achieved via the touch-sensitive screen, since many working processes that have to be controlled require the screen to be operated “blind” whilst the resulting action is observed at the same time. Examples of this that could be mentioned are, for instance, operating a medical unit such as an x-ray machine in which the x-ray tubes and the x-ray monitor, for example, have to be moved into a certain position, for which procedure a joystick is used in the prior art. The operator watches the movement of the components being actuated but does not look at the joystick that he is activating. The use of a touch-sensitive screen is not possible in such cases.

Furthermore, it is not usually possible for severely visually impaired or blind people to work on a touch-sensitive screen since the information displayed is per se communicated to the user optically and in successful cases the acknowledgement is only given optically.

It is therefore an object of the invention to provide a screen which gives the user a perceptible acknowledgement about a successful command input even when the screen is not being or cannot be looked at.

This object is achieved by the claims.

The invention makes provision for the integration of means for the generation of a haptically perceptible signal, which means generate such a signal when the touch has been sufficient to generate a corresponding command signal. The haptic signal is generated at the position touched, this being virtually simultaneous with the generation of the command signal such that it is ensured that the point on the user interface is still being touched. The said touch can be effected directly by the user, with the finger for example, but also indirectly, using an input pen that the user holds in his hand. In each case the user receives a haptically perceptible acknowledgement relating to the successful input of the command, which acknowledgement he perceives in cases of direct contact via his extremely touch-sensitive finger, and in cases of indirect contact, via the input pen or such like, which is intrinsically rigid and stiff and which does not absorb the haptic signal but rather transmits it further.

This enables the user to receive a perceptible acknowledgement signal in each case, irrespective of whether he is currently looking at the screen or not. As a result of the fact that the haptically perceptible signal is generated as a direct function of the generation of a signal generated by touch, it is likewise ensured that a haptically perceptible signal is produced in fact only when an actual signal generation and consequent command input have taken place, such that the possibility of misinformation is ruled out.

As a means for generating the haptically perceptible signal, a piezoelectric layer assigned to the user interface is provided, which layer is locally actuatable in the manner of a matrix. The piezoelectric layer can be electrically actuated locally, which results in the layer undergoing a three-dimensional deformation, which deformation is the point of departure for the haptically perceptible information that is to be provided to the user. The piezoelectric layer can be arranged above or below the user interface, the only important thing being that the piezoelectric layer does not influence the optical display of the relevant information on the screen surface or only does so to an insignificant extent. Normally an LCD-screen has an outer layer covering the liquid crystal matrix, on top of which the touch-sensitive plane is applied in a transparent form in cases where the screen is a touch screen. The design is similar in the case of other screens, e.g. a cathode ray monitor, an LED screen, a vacuum fluorescence screen, or a plasma or TV/video screen, on the screen surfaces whereof the touch-sensitive plane is applied. The design of a touch screen is sufficiently known and does not need to be explained in further detail. Now it is conceivable for the piezoelectric layer to be applied under this plane in a thin form that is inevitably transparent, together with control circuits that are likewise transparent, such that the information that can be provided haptically thereby is supplied direct to the touch-sensitive surface that has been actuated by the finger or pen or such like, which surface usually functions capacitatively, and is perceptible thereon. It is also conceivable, however, for the piezoelectric layer to be applied to the touch-sensitive surface as long as it is thin enough and if it has been ensured that, apart from being transparent, said surface is also sufficiently deformable to transmit the mechanical command input to the interface that lies underneath.

A particularly useful embodiment of the invention makes provision for the piezoelectric layer itself to be used to input the command and generate the command signal. This is a piezoelectric layer as described above, which is capable of effecting a change of shape when actuated electrically, and which is equally capable however, of generating an electric signal when effecting a geometrical change in shape. That is, it is possible to generate an electric signal when the layer is touched and deformation results therefrom and in the next step to generate the haptic information at this position almost simultaneously, by actuating the layer electrically.

The haptically perceptible signal can be actuated in the form of one or a plurality of local mechanical impulses that are generated by a deformation of the piezoelectric layer. This means that the user receives one or a plurality of mechanical impulses resulting from the deformation of the layer that has been induced by the electrical actuation. He therefore feels an impulse-like vibration in his finger as it were. Alternatively, the option of a mechanical vibration is also conceivable, that is, the respective section of the layer is actuated at the corresponding frequency in order to generate the vibration.

The fact that a device that generates a haptic signal has been incorporated not only offers the opportunity of generating a haptically perceptible acknowledgement in the case of a successful command input. A useful embodiment of the invention makes provision for a haptically perceptible second signal to be provided via the electrically actuatable means before a sufficient touch has occurred, which signal informs the user of the activation of the local area of the screen for a command to be input. That is, the user thus receives information as to whether the area of the screen that he would like to actuate has been activated at all, that is, whether a command input is at all possible via said area. He is provided with a haptic signal indicating the general activation and thus the opportunity for command input, for example a vibration at very low frequency that he can perceive from a light touch. If he then carries out a command input at this position, he is given the first signal acknowledging successful command input, with the result that he realizes that the desired command has in fact been accepted. Said signal then, for example, has a frequency higher than the signal previously given, which indicated the general activation. Alternatively, it is also conceivable for the first and the second haptic signal to be achieved in the form of mechanical pulses that have different intensities. To provide information on general activation, there can be a very slight deformation, by 1/10 mm for example, whilst, to provide acknowledgement of the successful command input, the display can be actuated with perceptibly greater intensity to achieve a perceptibly more extensive mechanical deformation and thus a perceptibly more extensive mechanical impulse. This information is very important for visually impaired people for example, especially in association with the opportunity that is also provided according to the invention for the local area/areas of the user interface to be displayed three-dimensionally via the electrically actuatable means where a command input is fundamentally possible. Via the above option, control elements that the user can sense can be produced three-dimensionally. Associated with the option for providing a vibration signal or suchlike indicating that such a control element has been activated, the user thus has the option of detecting in a simple manner and with certainty that he is touching the correct control element and can make the correct input.

As described above, the screen according to the invention offers in particular the option of using it virtually “blind”, after the user has received feedback as to whether he has actually input a command. Such commands can consist not only in the input of an individual command given via a simple single touch, but also in the manner that the corresponding position on the screen is pressed for the respective length of time in order to adjust or change a parameter or suchlike that is required for the control of a unit connected downstream or suchlike, for example, as a result of which, for example, the parameter changes, counting continually. In the case of the application described above, for the control of an x-ray machine, such a parameter that can be adjusted accordingly is for example the service voltage of the x-ray tube. Alternatively, a certain spatial position can be adopted, it being possible to adjust the x, y and z-coordinates via the screen. Now it can happen, that (insofar as said adjustment of the parameters is achieved more or less “blind”) as a result of the duration of the period of activation of the screen surface section, the parameter has been changed to a region that is unacceptable, or the parameter has been changed up to the maximum or minimum limit. In order to also give the operator information relating thereto, a useful embodiment of the invention allows the duration and/or intensity of the first haptic signal that is created when the extent of touch is sufficient and thus when an electrical command signal is created to be varied as a function of the information content of the command input that has been given, in cases where the user interface is touched continuously. This means that if, for example, the user changes the parameter to a region that can be hazardous, he receives haptic information which is, for example, perceptibly more intensive than the usual haptically perceptible signal and which, in such a case, is created almost continuously, which information informs him that he is, for example, correctly raising or lowering the parameter. Likewise, the vibration frequency of the haptic signal can change perceptibly, such that the user will be informed accordingly. It is also conceivable for the haptic signal to be discontinued abruptly, which the user will likewise register immediately. The variation of the duration and/or intensity of the first haptic signal depends on the content of the information that is given via the continuous actuation, that is, it depends defacto on the parameter that has been adjusted temporarily and is liable to change, or on suchlike.

As has already been disclosed above, it is possible for control elements to be displayed three-dimensionally using the three-dimensionally deformable and electrically actuatable means such as the piezoelectric layer. In the above case, a display using input keys or “buttons” should be considered in the first instance. It is also possible, however, to display control or sliding elements, similar to the “scroll bars” that are known from conventional screen displays, with which it is possible to “browse” on conventional PC-screens using the mouse cursor. In order to be able to achieve such a slide or slide controller in association with the haptically perceptible acknowledgement that is provided according to the invention, the means are actuated in such a way that a surface area in the form of a slide- or controller-type control element that has to be moved along a straight line can be actuated, in particular a haptically perceptible limit being created all round as a result of mechanical deformation by appropriately actuating the means during the movement, in the direction of the movement at least. The user thus moves a haptically perceptible “mountain” achieved by corresponding deformation of the deformable layer, he thus feels a certain resistance as the above “mountain” vibrates slightly if there is a movement or adjustment of the slide that is thus created, leading to the generation of a signal. When touched directly with the finger, the limit that is preferably provided all round further offers sufficient perception of the shape for the finger to be virtually guided. If an activating pen is used, the pen virtually rests in the groove created by the deformation, such that it is likewise gently guided and can be moved easily along the straight lines.

### BRIEF DESCRIPTION OF THE DRAWINGS

Further advantages, features and details of the invention will emerge from the embodiment described below and from the drawings in which:

FIG. 1 shows a sketch illustrating the principle of a touch-sensitive screen according to the invention, seen in a partial view in cross section,

FIG. 2 shows a view according to FIG. 1 with an actuated piezoelectric layer for the three-dimensional development of a control element and for the creation of a second haptic signal indicating the activation thereof,

FIG. 3 shows the view from FIG. 2 when inputting a command via a user interface and actuating the piezoelectric layer to create the haptically perceptible signal acknowledging the generation of the command signal.

FIG. 4 shows an exploded view of a screen according to the invention, showing a slide- or controller-type control element and

FIG. 5 shows two screen views together with details of the frequency of the haptically perceptible signal during a continuous parameter adjustment.

### DETAILED DECSRIPTION OF INVENTION

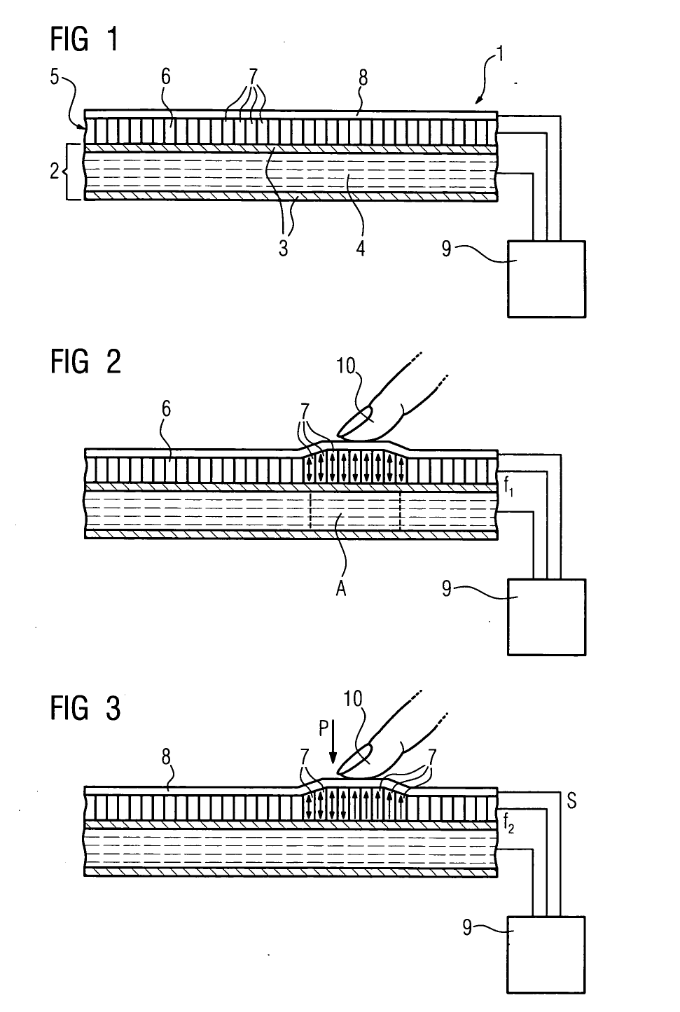

FIG. 1 shows a touch-sensitive screen 1 according to the invention in the form of a sketch illustrating the principle involved, the essential elements only being shown here. The screen in the embodiment shown comprises an LCD or liquid crystal display plane 2, consisting of a plurality of individual liquid crystal cells that are not shown in further detail, consisting of two upper and lower covering layers 3, the distance between which is generally lower than 10 μm. Each covering layer consists firstly of a glass plate, on the inner side of which transparent electrodes having a special orientation layer are applied. A polyimide layer is generally used as an orientation layer. An ITO (indium-doped tin oxide) layer is preferably used as a transparent electrode material. Between the covering layers 3 is the liquid crystal layer 4. The information content that can be displayed in a liquid crystal display is determined by the structuring of the transparent electrodes, which are manufactured primarily in an arrangement that can be shown diagrammatically. The design of such a liquid crystal display is actually known and therefore does not need to be disclosed in further detail.

On the upper side of the liquid crystal display 2, an electrically actuatable means 5 is applied in the form of a piezoelectric layer 6 that comprises a plurality of individually actuatable layer sections 7. Each layer section 7 can be actuated by an appropriate electrode matrix that is not shown in more detail. After the layer 6 has been disposed above the liquid crystal display 2, said layer and likewise the electrode matrix have to be transparent, so that it is possible for the information shown on the liquid crystal display 2 to be recognized.

On the upper surface of the piezoelectric layer 6 the touch-sensitive surface 8 is applied, consisting of a touch-sensitive, usually capacitative matrix, which when touched and when mechanical deformation occurs, generates an electric signal at the site of deformation, which signal can be detected and which represents in electrical form the command signal that has been input by the user. Both the mode of functioning and likewise the design of such a touch-sensitive user interface are known so that there is no need to go into this in further detail.

The central element is the electrically actuatable means 5 in the form of the piezoelectric layer 6 that is described here. Any piezoelectric material that allows the creation of a sealed layer covering a wide area can be used to create the piezoelectric layer 6. Piezoelectric materials on a ceramic basis that can be manufactured in a polycrystalline form, such as for example, mixed Pb(Zr—Ti)O₃ crystals (so-called PZT-ceramics) and the like can be mentioned in particular. Piezoelectric polymers such as polyvinylidenedifluoride (PVDF) for example can likewise be used. This list is not conclusive, but merely serves as an example. The mode of functioning of said piezoelectric layer 6 is shown in FIGS. 2 and 3.

Assigned to the screen 1 is a control device 9, for the control thereof, which firstly controls an image shown via the liquid crystal display 2, and which further communicates with the piezoelectric layer 6 and with the user interface 8.

Proceeding from the image shown via the liquid crystal display 2, it is possible by means of corresponding actuation of the piezoelectric layer to display three-dimensionally, by means of the piezoelectric layer 6, a control element, for example, which is only displayed optically by the liquid crystal display 2 in the area A that is shown with a dotted line in FIG. 2, that is, it is possible to display said control element externally in a manner that can be felt by touch. For this purpose, via the actuating electrode matrix that is not shown in further detail, a plurality of local layer sections 7, which are arranged above the region A of the liquid crystal display A in which the control element is shown optically, are actuated such that they change their shape and as a result thereof a local increase can be achieved in said area, as is shown in FIG. 2. After the user interface 8, which is sufficiently flexible, has been directly connected to the piezoelectric layer 6 said layer is also deformed such that a slight convexity can be felt corresponding with the position of the control element that is shown.

In order to give the user a first message to the effect that the control element which is shown three-dimensionally (especially when a plurality of such control elements are shown simultaneously on the screen), has also been activated for a command input, that is, that such an input is therefore possible via the control element, the piezoelectric layer 6 or the layer sections 7 that have already been actuated and deformed in order to display the control element is/are actuated in such a way via the control device 9 that they vibrate at a certain, preferably relatively low, frequency f₁ as is shown by the two-headed arrows in the respective layer sections 7. This means that not only does the user feel the position of the control element and know that he is touching the correct section of the user interface with his finger 10, but he also immediately receives through his finger a haptically perceptible information signal indicating that he can in fact input a command via said control element. During actuation, during which the voltage that induces the geometrical deformation of the piezoelectric layer sections is varied according to the frequency f₁, the electrically induced displacement of the piezoelectric sections continuously changes, whilst at the same time a minimum displacement is retained to show the three-dimensional control element.

If the user, having ascertained haptically that he can in fact input a command via the control element that he has touched, actually wishes to make such an input, he presses with his finger 10 on this section of the user interface 8, as shown in FIG. 3 by the arrow P. This leads firstly to the detection matrix of the user interface 8, which, as mentioned above, is not shown in further detail, producing an electric signal S when the touch is sufficient, which signal shows the electric information as the consequence of the command input. Said signal S is transmitted to the control unit 9. As soon as the signal is present, the control device 9 then actuates the layer sections 7 that have already been actuated beforehand in such a way that they vibrate at a frequency f₂ which is perceptibly higher than the frequency f₁ in order to give the user the haptically perceptible acknowledgement signal to the effect that his command input has been recognized and that a command signal has been generated. The user can perceive a clear difference in the information that has been given to him.

As an alternative to changing the frequency between the two states “indicating an active state” and “acknowledgement following the input of a command,” it is also possible to vary the mechanical impulse that can be generated via the layer sections 7 and the deformation thereof. Proceeding from FIG. 2, the layer sections 7 can be actuated at a low voltage to provide the information “active state” such that the displacement thereof is slight and consequently a lower mechanical deformation and thus a weaker impulse is transmitted, whilst to provide the “acknowledgement,” the layer sections 7 are actuated at the same frequency but at a higher voltage, which leads to a perceptibly greater mechanical displacement and thus to a stronger mechanical impulse that can be perceived by the user.

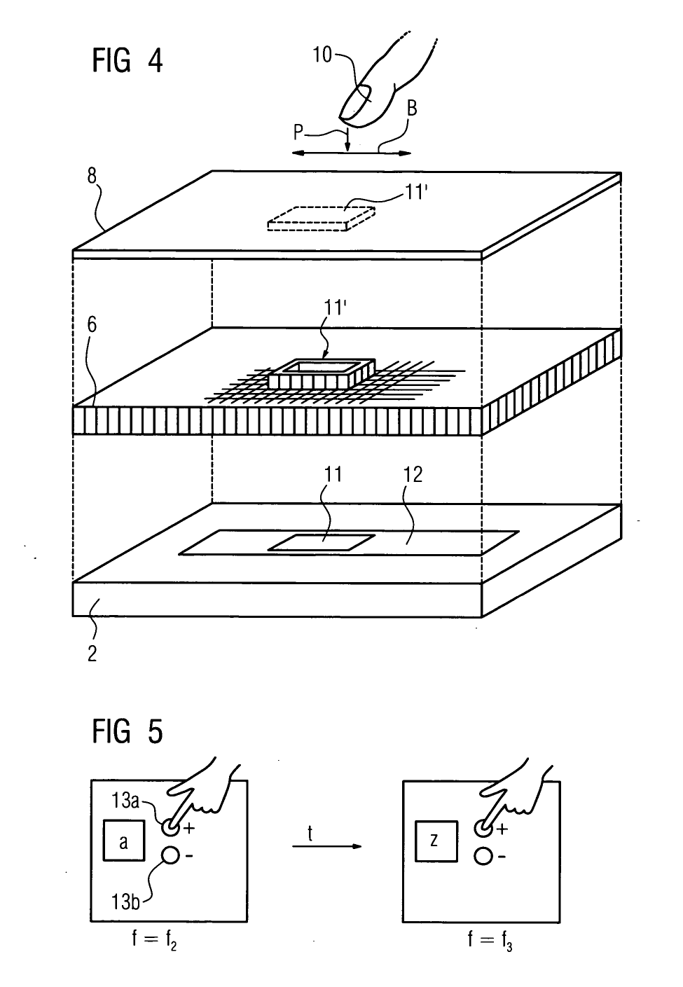

In the form of a sketch illustrating the principle involved, FIG. 4 gives an exploded view showing the elements known from FIG. 1, the liquid crystal display 2, piezoelectric layer 6, and user interface 8. The liquid crystal display 2 shows in the example used a slide 11, which slide can be “moved” along a track 12, which is also shown, in order to input a command. A corresponding “slide 11′” is replicated by corresponding actuation of the piezoelectric layer 6, the piezoelectric layer sections 7 being actuated in such a way that a lateral limit for the slide 11′ is created, so that firstly said slide 11′ can be felt on the user interface 8 by the user through his finger 10 and secondly a slight hollow is created or can be felt, which hollow is made by the layer sections 7 limiting it at the edges, which sections are actuated and thus deformed. Said hollow receives the finger 10 (or even a user pen or suchlike which is held in the hand) and guides it slightly. If the slide 11 or 11′ is/are now moved along the track 12, the finger 10 first presses the slide 11′ which is represented three-dimensionally, as shown by the arrow P and then pushes it to the right or left along the straight track 12 as shown by the two-headed arrow B. Depending on the direction of movement, there are continual changes in firstly the actuation of the piezoelectric layer sections 7 in order to complete the slide movement three-dimensionally and represent it in a haptically perceptible manner. After there has also been a continuous command input resulting from the movement of the slide 11′, that is, in response to a change in a control or regulating parameter, the part of the layer sections 7 of the piezoelectric layer 6 used to generate the vibration or impulse signal is actuated via the control device 9 that represents the acknowledgement, said part being that virtually in front of the finger 10 in the direction of movement. Thus the user therefore likewise continuously receives information to the effect that the slide- or control change has also actually resulted in the generation of a corresponding command signal.

In the form of a sketch illustrating the principle involved, FIG. 5 now gives two views of the screen which show the adjustment of any parameter e.g. of an operational parameter of a unit or a machine. In the left-hand view of the screen, the initial parameter is the parameter “a”, which can be arbitrary in nature and have an arbitrary information content. Assigned thereto are two control elements 13, which can be displayed to the user three-dimensionally in the manner described above. Let us assume that the user would like to change the parameter “a”, which is possible by pressing the control element 13a, which is marked with the “+” sign. The adjustment of the parameter is to be achieved blind, for instance, since the user would like to look at another part of the unit, on which the reaction to his adjustment of the parameter can be seen.

If the control element 13a, which is marked with the “+” sign is pressed, it first vibrates at the frequency f₂, that is, at the frequency that has already been described, which represents the acknowledgement relating to the forthcoming generation of the command signal and thus of the change in the parameter resulting therefrom. The parameter “a” changes continuously, as long as the control element 13a is pressed. This is effected for a time Δt, until the parameter has changed to its maximum value “z”. A further change of parameter is impossible or would result in the parameter being changed into a danger zone, which is not supposed to happen. In order to inform the user thereof, the frequency at which the acknowledgement signal is generated via the piezoelectric layer and hence via the control element 13a changes perceptibly compared to the frequency f₂, such that the user can easily detect this. For example, the frequency can be perceptibly higher, but it can also be zero, that is, the vibration suddenly stops. The user is warned directly thereof.

There is also of course the option in such a case of generating an acoustic signal in parallel. The change in the impulse produced can also be varied accordingly.

Finally, it should be emphasized that, instead of the liquid crystal display 2, any other display or presentation device can of course be used, for example, TFT displays, cathode ray screen or suchlike. The liquid crystal display is only one example and is by no means restrictive.

1-7. (cancelled)

8. A screen having a touch-sensitive user interface for inputting a command by touching the user interface and generating a command signal if the degree of touch is sufficient, comprising:
an electrically actuatable mechanism assigned to the user interface for generating a first haptically perceptible signal at the position touched on the user interface if a command signal has been generated after touching the user interface by a user, wherein
the mechanism comprises a locally actuatable piezoelectric layer, wherein
the haptically perceptible signal includes any of one or a plurality of local mechanical impulses, or a local mechanical vibration generated by a deformation of the piezoelectric layer, wherein
the electrically actuatable mechanism is adapted to generate a second haptically perceptible signal before a sufficient degree of touch at a local area of the screen occurs indicating to the user that the local area of the screen has been activated for inputting a command, and wherein
the first and the second haptic signal comprise any of different frequencies, or different mechanical impulses.

9. The screen according to claim 8, wherein the piezoelectric layer is arranged above or underneath the user interface.

10. The screen according to claim 9, wherein the piezoelectric layer is used for inputting a command and generating a corresponding command signal.

11. The screen according to claim 8, wherein a duration and/or an intensity of the first haptic signal are varied during a continuing touching of the user interface depending on the information content of the input command.

12. The screen according to claim 8, wherein such local areas of the user interface, where a command input is possible, are represented three-dimensionally by the electrically actuatable mechanism.

13. The screen according to claim 12, wherein a surface area in the form of a slide- or controller-type control element movable along a straight line is represented by the electrically actuatable mechanism, and wherein,
during movement, the control element is limited at least in the direction of its movement in a haptically perceptible manner by the deformation of the actuated piezoelectric layer.

14. The screen according to claim 12, wherein a surface area in the form of a slide- or controller-type control element movable along a straight line is represented by the electrically actuatable mechanism, and wherein
the control element is limited circumferentially during its movement in a haptically perceptible manner by the deformation of the actuated piezoelectric layer.
